(19) United States
(12) Patent Application Publication
(10) Pub. No.: US 2012/0305495 A1
(43) Pub. Date: Dec. 6, 2012

(54) SUBMERSIBLE REACTOR AND/OR CIRCULATION APPARATUS

(75) Inventor: Mehdi Siami, London (GB)

(73) Assignee: Aquafide Engineering Limited, East Sussex (GB)

(21) Appl. No.: 13/575,663

(22) PCT Filed: Jan. 26, 2011
(86) PCT No.: PCT/GB11/50125

§ 371 Date: Jul. 27, 2012

(30) Foreign Application Priority Data
Jan. 28, 2010 (GB) 1001391.0

(51) Int. Cl. C02F 1/74; C02F 1/48; C02F 1/46; C02F 3/22

(52) U.S. Cl. 210/748.02; 210/220; 210/150; 210/758; 210/748.01; 210/763

(57) ABSTRACT

A liquid contaminant-extraction apparatus arranged for submersion in liquid such as water and comprising a draft tube arrangement extending from an upper region of the apparatus to a lower region thereof, floatation means provided at the upper region, gas introduction means located at the lower region and arranged for the introduction of gas into the draft tube arrangement to create an air lift for water therethrough and for the said extraction of contaminants therefrom.

The present invention relates to a liquid circulation apparatus and related method, and in particular to a liquid treatment apparatus and method such as a contaminant-extraction apparatus and related method for use in relation to water.

For various reasons and can prove desirable to provide for a, preferably controlled, movement of liquid such as, for example, within a water tank/reservoir. As discussed further below, the stratification that can occur for example in the summer months in lakes can prove problematic.

Also, for health and sanitation purposes, a variety of water-treatment procedures are known and used during the collection, storage and/or distribution of potable water and which involve the movement of at least part of the body of water.

Such treatments are predominantly chemical in nature and it is quite often found that while one treatment step might necessarily have a desired result in removing, or at least reducing the concentration of, a particular contaminant, by-products might nevertheless be formed whose concentration should also be limited, or perhaps or whose presence should be eliminated.

For example, chlorine is the most commonly used disinfectant in many water treatment plants. It reacts with the natural organic matter in water and produces a variety of disinfection by-products (DBPs). Natural organic matter, arising from decaying vegetation and algae, are present in almost all drinking water sources.

The two largest classes of chlorination by-products detected in treated drinking waters are trihalomethanes (THMs) and haloacetic acids (HAAs).

Toxicology studies have shown several DBPs (including THMs and HAAs) to be carcinogenic or to cause adverse reproductive or developmental effects in laboratory animals. Numerous epidemiology studies have suggested an increased cancer risk to individuals who consume or are exposed to chlorinated waters.

Because of the serious health risk which is represented by THMs and HAAs, regulatory action has been taken to control the levels of these DBPs in finished drinking water. For example, the US Environmental Protection Agency has established maximum contaminant levels for the sum of four THMs and five HAAs at 80 and 60 μg/L, respectively, in drinking waters. The Commission of the European Communities has also proposed a Council Directive with parametric values of 40 and 15 μg/L for chloroform and bromodichloromethane, respectively, and the level of 100 μg/L for Total THMs.

Closed processes involving air extraction are known which provide for a once-through treatment of the water and in which the collection and evaporation and extraction of contaminants, occurs within an enclosure which disadvantageously limits the potential practical capabilities of such apparatus and the overall efficiency thereof and also it is considered to be a relatively expensive procedure for contaminant removal.

Returning to the question of stratification, during the summer months in particular, the upper parts of the water in a lakes etc are warmed by the sun and tend to stay warmer during the night. However, the lower levels remain cold. Due to these differences in temperature, and related differences in density, the colder water remains in position towards the bottom of Lake and so the lower layers tend to become isolated and are unable to receive any more oxygen from the surface. This leads to stratified body of water forming in a lake which is characterised by an upper layer (Epilimnion), a transition or boundary layer (Metalimnion) and the lower, colder, layer (Hypolimnion).

It has been recognised that in some lakes, stratification can have a huge ecological and economic impact.

It has long been known that the most common way to overcome stratification within a lake is to introduce rising plumes of bubbles to help cause motion within the water body and thereby attempt to alleviate the associated water quality problems. This is a relatively simple procedure in which air is released from a point source on the lake bed thereby creating the required plume of bubbles rising to the surface. However, such a system has proven disadvantageous insofar as they are not energy efficient, generally prove expensive to install and maintain and are not always considered particularly successful.

Specific limitations of that, even though the air bubbles are caused to pass through the water body, only a small fraction of oxygen added to water originates from oxygen transfer from the bubbles. The majority of the oxygen originates from increased oxygen transfer at the surface boundary of the lake and which results from the bubbles emerging at, and agitating, the surface. Also, in shallower water bodies, the number of bubble plumes required to mix the water is significantly increased since, in shallow waters, effective area of the plume at the surface is restricted: it being appreciated that the effective area of the bubble plume increases with depth due to the tendency of the bubble to spread outwardly during its upward journey to the surface.

Yet further, it is noted that, in some instances, when the bubbles reach the surface, they fail to carry anoxic water with them from the Hypolimnium. This occurs particularly in heavily stratified waters due to the change in density at the Metalimnion; the effects of which can prove difficult to overcome for the bubble plume. The rising plume entrains the cold heavy water to the Metalimnion and, while the bubbles continue to rise as they are obviously much more buoyant, the water entrained from the Hypolminium remains much heavier than the warmer less-dense water above the Metalimnion and so falls away from the plume and back down into the water body to a level exhibiting equivalent buoyancy. In other instances, the rising plume can prove too effective in entraining water from the lower regions of the lake. If too effective, the plume will also bring with it nutrients from the settlement of the lake bed where, at the surface, the introduction of such nutrients can trigger an algal bloom, to the detriment of the lake ecology.

Thus, it will be appreciated that known attempts to de-stratify lakes can prove limited and often disadvantageous.

The present invention seeks to provide for liquid movement apparatus, and a related method, having advantages over known such apparatus and methods.

In particular, the present invention seeks to provide for water treatment to overcome stratification and/or provide for contaminant-extraction from water having overall efficiency and cost-effectiveness which is attractive when compared with known such apparatus and methods.

According to a first aspect of the present invention there is provided a liquid treatment apparatus arranged for submersion in the said liquid and comprising a draft tube arrangement extending from an upper region of the apparatus to a lower region thereof, floatation means provided at the upper region, gas introduction means located at the lower region and arranged for the introduction of gas into the draft tube arrangement to create a lift for liquid there-through and for the said treatment thereof.

The invention proves particularly advantageous insofar as, as part of the treatment process, it allows for the recirculation of the liquid so that the apparatus comprises more than a “one-through” arrangement, and can generally provide for a more controlled and focused approach to treating the whole body of water. With regard to the above definition of this invention, and the further discussion contained herein, it should be appreciated that reference to “treatment” can include active treatment so as to improve the quality of the liquid through, for example, contaminant-extraction, and whether or not including active packing means within the draft tube arrangement; and can also include treatment of the body of water merely through its mixing in an attempt to overcome for example, problems associated with stratification.

Structurally, the apparatus can prove to be relatively simple and readily deployed and manoeuvred as required particularly since only a limited number of moveable parts may be necessary and the active treatment of the water can be achieved by the aforesaid air lift.

Even though the rate of treatment, for example contaminant-extraction, could be considered to be limited for each volume of liquid that passes upwardly through the draft tube from the lower region to the upper region thereof, insofar as the apparatus allows for continuous recycling of the liquid, the over all degree of “treatment” will increase with time as the water is recycled through the draft tube.

Also, provision of the draft tube which can readily extend from the surface of, for example, a water reservoir, to a region proximate to the reservoir floor, allows for circulation of the near complete volume of the water body, in an efficient and in particularly cost-effective manner.

The provision of the draft tube allows for more than mere localised treatment of the area around the air plume since liquid from the complete reservoir area is drawn into the lower region of the draft tube advantageously by the air lift action upwardly within the draft tube.

Preferably, the draft tube is formed from at least two telescopic sections so that the longitudinal dimension of the draft tube can vary responsive to a change in depth of water and so as the water level in, for example, the reservoir changes.

The floatation means provided in the upper region of the draft tube serves to allow for extension or retraction of the then telescopic draft tube.

Advantageously, at least the lower region of the draft tube is provided with support members extending therefrom for engagement with the lower surface of the formation within which the liquid is stored, i.e. such as a reservoir floor.

Such engagement means can also advantageously comprise means for raising the intake above any sediment or for establishing a minimum distance from the intake to the reservoir floor.

According to one particular advantageous embodiment of the present invention, packing means can be provided within at least a portion of the draft tube.

Advantageously, the packing means serves to interfere with the upward passage of liquid and gas to advantageously increase the extent, and the time for which the liquid and gas remain in contact, hence improving extraction efficiencies.

Additionally, or alternatively, an active medium can be provided within the draft tube to remove other contaminants from the liquid as it passes through the draft tube.

Additionally, or alternatively, a catalytic medium can be provided within the draft tube to provide liquid quality improvement.

Advantageously, the active medium comprises the said catalytic medium and which can be provided as part of, or associated with, the aforementioned packing.

Additionally or alternatively, and particularly if the invention is arranged for waste water applications the packing means can be provided to support growth of biological fixed film for removing organic contaminants from water

Additionally or alternatively, electromagnetic radiation such as UV light and/or magnetic field and/or ultrasound can be applied to the water passing through the apparatus to improve the liquid quality.

Apertures can also be provided at selected regions through the wall of the draft tube so as to allow for the additional points of introduction of liquid in to the draft tube and as a result of the said air lift.

An impeller arrangement can likewise be provided in relation to the draft tube and for assisting with movement of liquid through the draft tube.

In particular, the impeller arrangement can be provided so as to urge liquid downwardly through the draft tube and in the direction opposite to that of the gas rising therethrough from the gas introduction means.

The gas introduction means can comprise one or more appropriately located gas diffusers, or alternative means for example venturi effect arrangements such as a venturi eductor particularly if space is limited.

Within the present description, it should be appreciated that reference to gas is intended to include air and vice versa. As noted, while invention is related to the treatment of any appropriate liquid, one particular arrangement relates to water treatment and, in particular, potable water treatment.

As further features, baffles can be provided inside the draft tube so as to urge the fluid along a particular path. Such baffles can be provided in the manner of the rifling of a gun barrel so as to encourage swirling motion of the fluid. Also, the upper and lower regions of the apparatus can be provided with a diffuser and/or baffling so as to achieve a required flow-direction/pattern and to prevent potential energy loss and/or the appearance of dead zones.

Should also be appreciated that reference to draft tube is encompasses any appropriate cylindrical configurations whether other of circular, rectangular or any other appropriate cross-section. Any appropriate arrangement can be provided for allowing variation in the height of the apparatus, whether as a telescopic, concertina or other collapsible arrangement.

According to another aspect of the present invention there is provided a method of contaminant-extraction from a liquid body and including the step of drawing liquid through a draft tube submersed within the said liquid by means of air lifting and whereby the introduction of the gas so as to provide for the air lift also provides for the said contaminant extraction.

It will of course be appreciated that the method of the present invention can also include further steps in accordance with the additional optional features discussed in relation to the above mentioned apparatus.

The invention is described further hereinafter, by way of example only, with reference to the accompanying drawings in which:

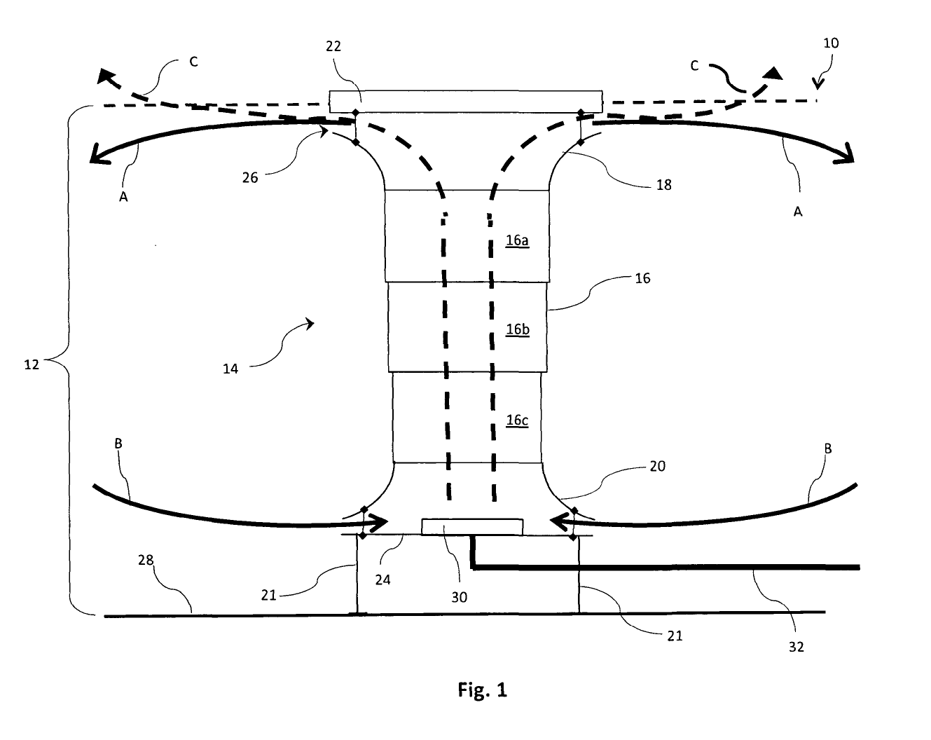

FIG. 1 is a simplified side elevation view of a water contaminant-extraction apparatus according to an embodiment of the present invention and in a first operational mode;

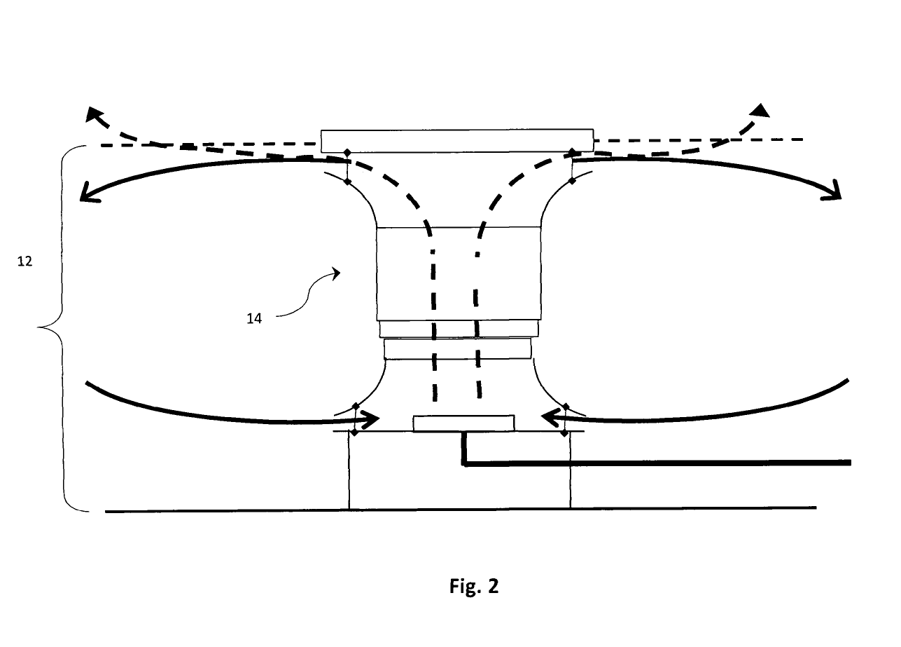

FIG. 2 is a view of the same apparatus as that of FIG. 1 but illustrated in a second operational mode;

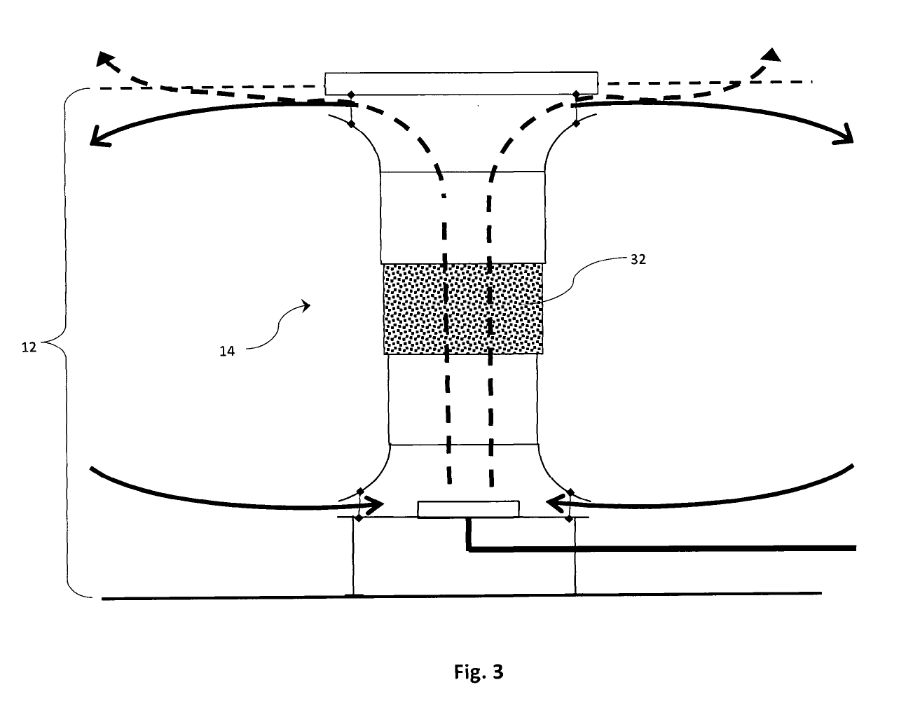

FIG. 3 is a simplified illustration of a water contaminant-extraction apparatus according to another embodiment of the present invention;

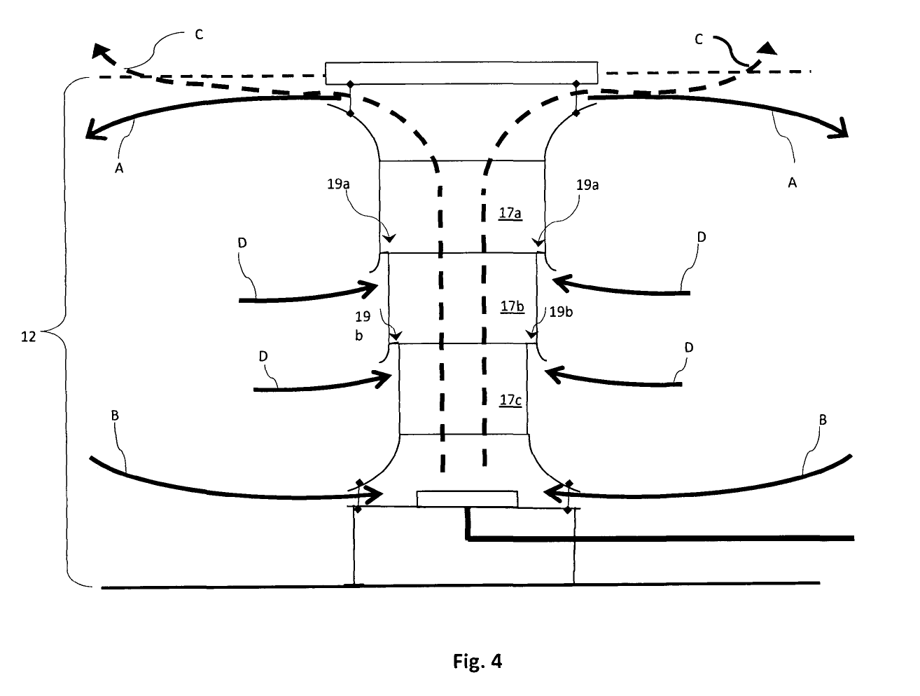

FIG. 4 is a simplified illustration of a water contaminant-extraction apparatus according to yet another embodiment of the present invention;

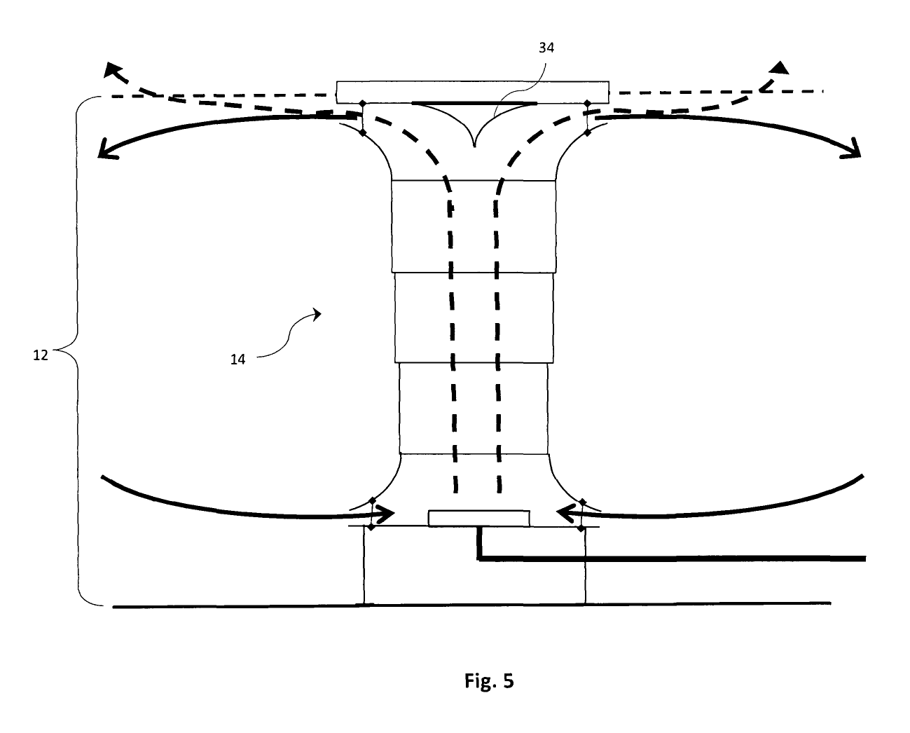

FIG. 5 is a simplified illustration of a water contaminant-extraction apparatus according to yet a further embodiment of the present invention;

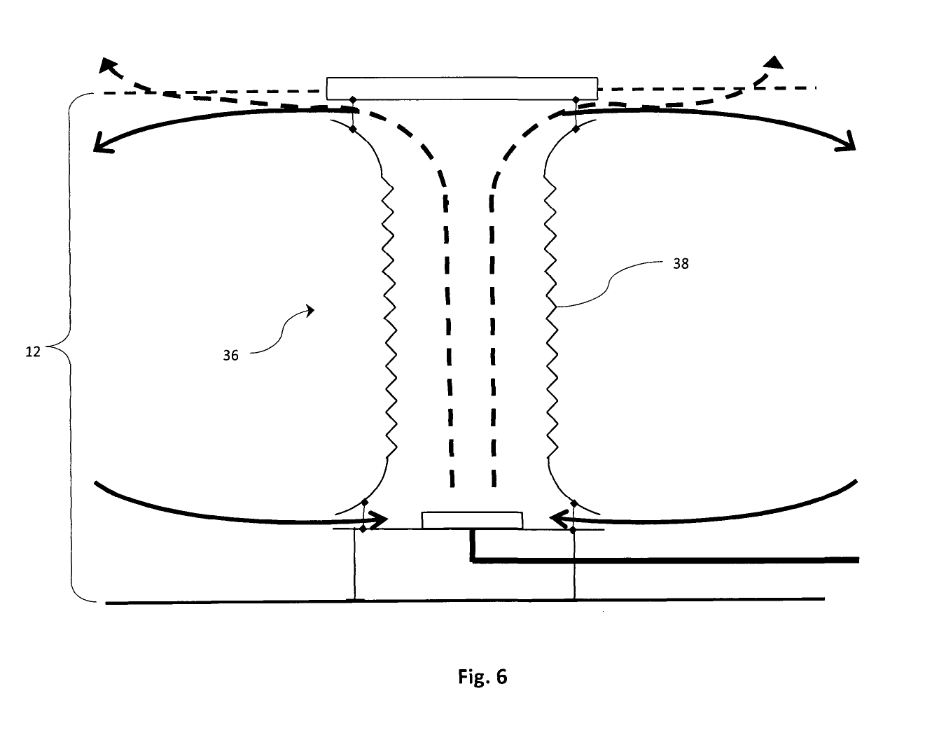

FIG. 6 is a simplified illustration of a water contaminant-extraction apparatus according to still another embodiment of the present invention;

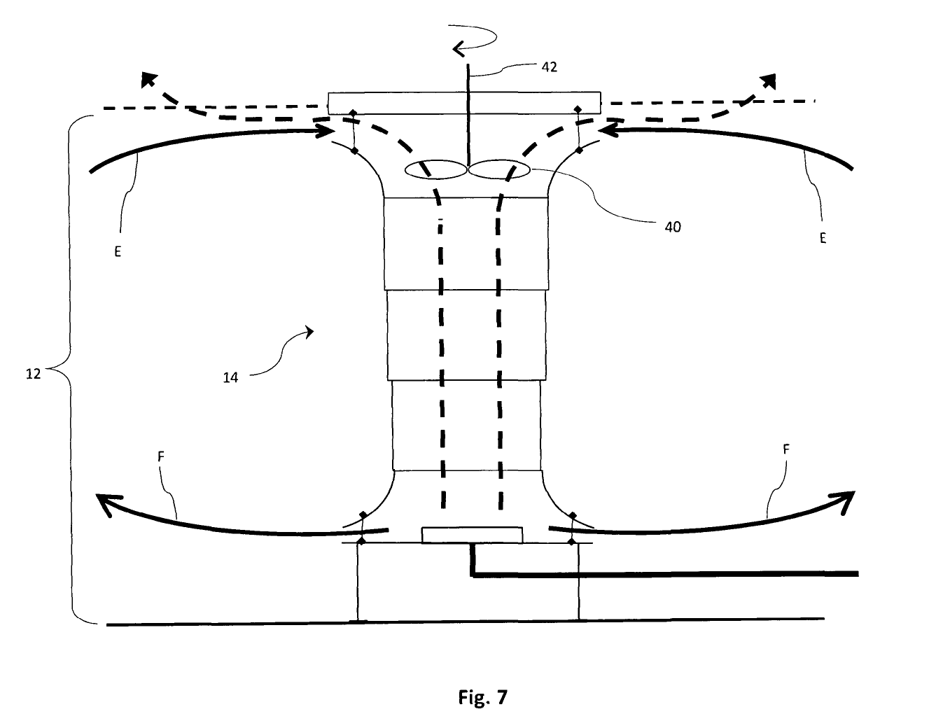

FIGS. 7-10 comprise simplified illustrations of water contaminant-extraction apparatus according to yet further embodiments of the present invention;

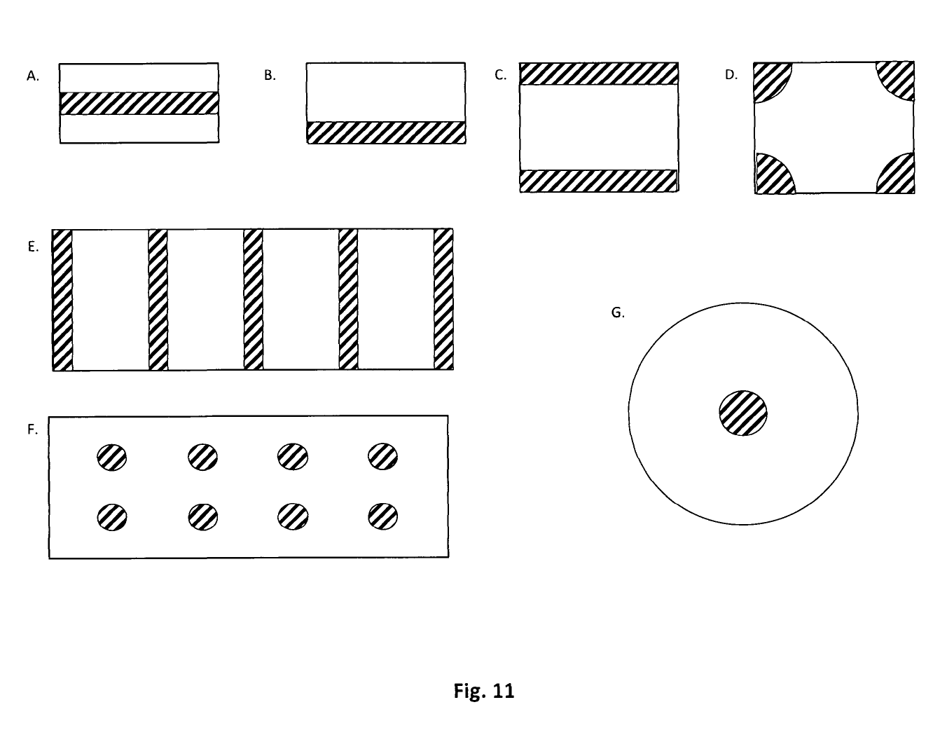

FIGS. 11A-11G comprise schematic illustrations of deployment patterns of apparatus embodying the present invention; and

Turning first to FIG. 1, there is illustrated a water storage arrangement such as a reservoir 10 having a current depth 12 and within which a water contaminant-extraction apparatus 14 embodying the present invention is submerged.

The apparatus 14 includes a draft tube 16 which is telescopic in nature and comprises three telescopic sections 16a, 16b and 16c.

The draft tube 16 extends from an upper region 18 formed as a bellmouth or other flow diffuser to a lower region 20 also formed as a bellmouth or other flow diffuser.

The upper bellmouth 18 engages with a flotation member 22, and is generally suspended there-from and the separation between the flotation member 22 and the upper bellmouth 18 defines an annular outlet 26 through which water and air escape from the draft tube 16 during the circulatory process in the direction of arrows A and C.

The lower bellmouth 20 engages with a lower base 24, and is generally raised there-from and the separation between the lower base 24 and the lower bellmouth 20 defines an annular inlet through which water enters the draft tube 16 during the circulatory process in the direction of arrows B.

Thus, the draft tube 16 extends from the bellmouth at the water surface downwardly to the lower base 24 which is provided in proximity to the reservoir bed. The extension of the draft tube in this manner advantageously serves to enhance the overall circulation of the water in the reservoir 10.

As will be appreciated from subsequent discussion, the relative extent of the extension of the draft tube 16 from the surface of the water to a region approximate to the reservoir bed is maintained irrespective of a change in depth of water in the reservoir due to the provision of floatation member 22. Of course, any appropriate floatation arrangement can be provided such as, for example, a flotation collar conforming to the shape of the diffuser. Any appropriate floatation arrangement can be employed as best suited to the local conditions.

At the lower region of the draft tube there is provided a gas diffuser 30, with associated gas-supply conduit 32 to which gas can be introduced into the reservoir for upward movement through the draft tube 16 in the direction of arrows C.

As will be appreciated, the introduction of gas in this manner serves to provide for an air lift by which water within the reservoir is drawn into the draft tube 16, moved upwardly, and finally exits at the surface of the reservoir via the bellmouth 18.

The lower base 24 of the bellmouth 20 has optional support legs 21 suspending downwardly there-from for contact with the reservoir bed 28 to help stabilise the draft tube 16. Advantageously, the length of the legs 21 can be varied so as to vary the height of the base 24, and thus the gas diffuser 30, from the reservoir bed 28. This has the advantage of limiting the influence that the circulatory motion introduced by the draft tube 16 might have on settlement at the reservoir bed thereby limiting the ecological impact of use of the apparatus.

As a further possible feature, the flow characteristics of water through the arrangement, e.g. volumetric flow and velocity, can be adjusted through variation in the dimensions/characteristics/configuration of the gap through which the water flows out of. Such control can be achieved by lowering/raising the effective diffuser weir, and/or by varying the speed of the impeller, and/or employing changeable/variable impellers offering varying blade numbers/angles.

As will be clarified further below, not only does the gas provide for the air lift and ongoing circulation of the water within the reservoir, but also advantageously provides for the required contaminant-extraction.

The effect of the air lift provided through the draft tube 16 in the direction of arrows C is that water within the reservoir is drawn upwardly through the draft tube 16 and exits in the direction of arrows A whereas water is likewise drawn into the lower region 20 of the draft tube 16 in the direction of arrows B. As will be appreciated, the direction and lateral extent of the arrows are indicative of the nature of the circulatory flow of water and indicate how, advantageously, and over time, water will be drawn in from all regions of the reservoir for treatment within the draft tube 16.

According to a yet further possible feature, the inlet and/or outlet diffusers, such as the bellmouths discussed herein, can be formed of a collapsible configuration which can lead to an advantageous reduction in their weight, and the ready availability for their use in shallower waters. For example, such a diffuser can be formed of flexible sheeting material configured, even by sowing, in the form of a required a bellmouth, but also including a generally rigid supporting skeleton structure, such as support rings, to generally maintain the required cross-sectional shape. Such structure however remains (totally) collapsible along its longitudinal/vertical axis, possibly in a similar “telescopic” manner to embodiments of the draft tube has also discussed herein.

Turning now to FIG. 2, there is a similar view of the apparatus 14 of FIG. 1 but illustrated here in a second operational mode corresponding to that which occurs once the depth 12′ of water within the reservoir has reduced.

The advantageous telescopic effect of the draft tube 16 of FIG. 1 is clearly evident from the illustration provided by FIG. 2.

The treatment of water rising through the draft tube 16 can be enhanced by the addition of a packing material 32 such as that illustrated in the embodiment of FIG. 3. The packing can comprise any appropriate material which advantageously serves to seek to obstruct the passage of water through the draft tube and thereby increase the time, or extent to which, the gas is in contact with the water and hence improve efficiency of the apparatus.

Advantageously, the packing material can also include an active and/or catalytic medium serving to enhance the contaminant-extraction of the water passing therethrough.

It should of course be appreciated that any appropriate fluidised or structured packing material can be provided such as, for example, activated carbon, a manganese removal catalyst, ion exchange resins etc., as required.

With regard to FIG. 4, there is a further adaption of the present invention wherein the lower regions of the outer surfaces of the telescopic section 17a, 17b out of the three telescopic sections 17a-17c of a draft tube are provided with circumferentially spaced apertures 19a and 19b respectively which allow for water to be drawn into the draft tube as illustrated by arrows D.

Of course, it should be appreciated that there could be two, or indeed more than three, sections and the overall dimensional is of course dependent upon the depth of the body fluid within which the apparatus is located. Also, any appropriate collapsing arrangement can be provided and examples of possible alternatives comprise concertina arrangements such as discussed below in relation to further embodiments of the present invention.

This can prove advantageous for further assisting with the overall circulation of water through the contaminant-extraction procedure by the present invention.

FIG. 5 is a view that of FIG. 1 up of another embodiment of the present invention. The details of the draft tube 16 of this embodiment are generally similar to those of FIG. 1 with the exception that the undersurface 34 of the flotation member is configured with a baffle so as to direct the flow out of the draft tube 16 and advantageously to reduce potential energy losses.

The FIG. 6 embodiment of treatment apparatus 36 according to the invention illustrates an alternative configuration for the draft tube 38. As will be appreciated, rather than being telescopic, the draft tube 38 maintains its important “collapsible” characteristic but achieves this through a concertina type configuration as illustrated. Such a configuration can prove advantageous if, for example, the reservoir bed is not horizontal or is generally uneven since one side of the draft tube 38 can extend to a lower degree than the other.

FIG. 7 illustrates yet another embodiment of the present invention in which the relative motion of the water through the draft tube is provided by means of an impeller arrangement.

A rotatable shaft illustrated schematically 42 is provided in the upper region of the draft tube and is arranged to drive an impeller member 40 in a manner so as to direct water downwardly through the draft tube. The shaft may be driven by solar, wind or some other power source as appropriate. Water then enters the draft tube in the direction indicated by arrows E, and exists that the lower region in the direction of arrows F.

However, gas is still introduced into the draft tube by means of a gas diffuser positioned at the lower region thereof, such that the gas travels upwardly and in a direction opposite to that of the downwardly moving water.

The agitation and potential mixing between the rising gas and falling water is therefore enhanced so as to likewise enhance the efficiency of contaminant-extraction.

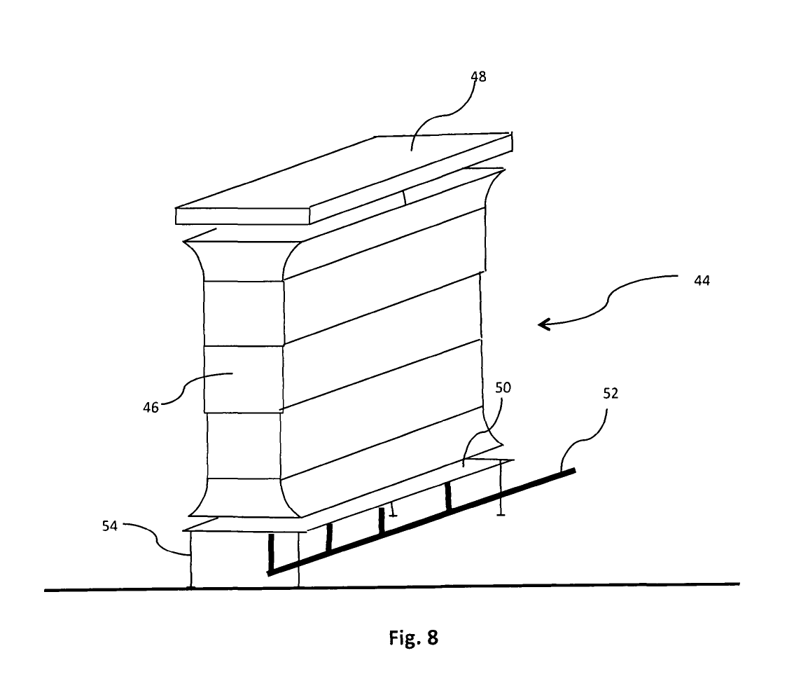

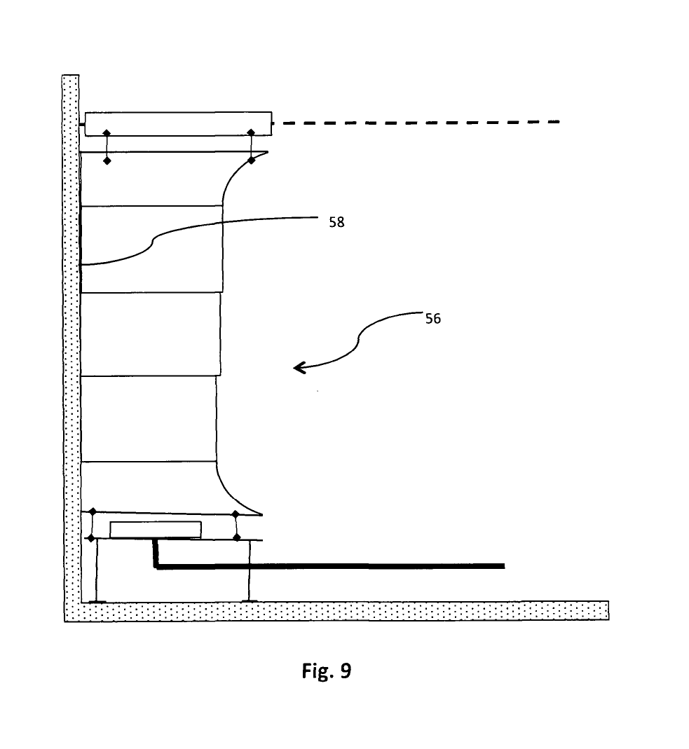

Of course, it should be appreciated that within the present application reference to the draft tube is not limited to a circular tubular consideration and any appropriate and/or required form/shape can be provided whether rectilinear or otherwise. As an illustration of this, FIG. 8 is an embodiment employing any rectilinear apparatus of 44 having a rectangular draft tube 46 and associated with a rectangular flotation number 48, and base number 50, of similar footprint. A gas/air supply pipe 52 is further illustrated extending along the longitudinal extent of the apparatus 44, which apparatus is supported on the reservoir bed by means of four support legs 54. FIG. 9 provides an illustration of apparatus 56 according to a slightly altered version of the FIG. 8 embodiment in which one side surface has a flat configuration for abutting against a side wall 58 of the reservoir.

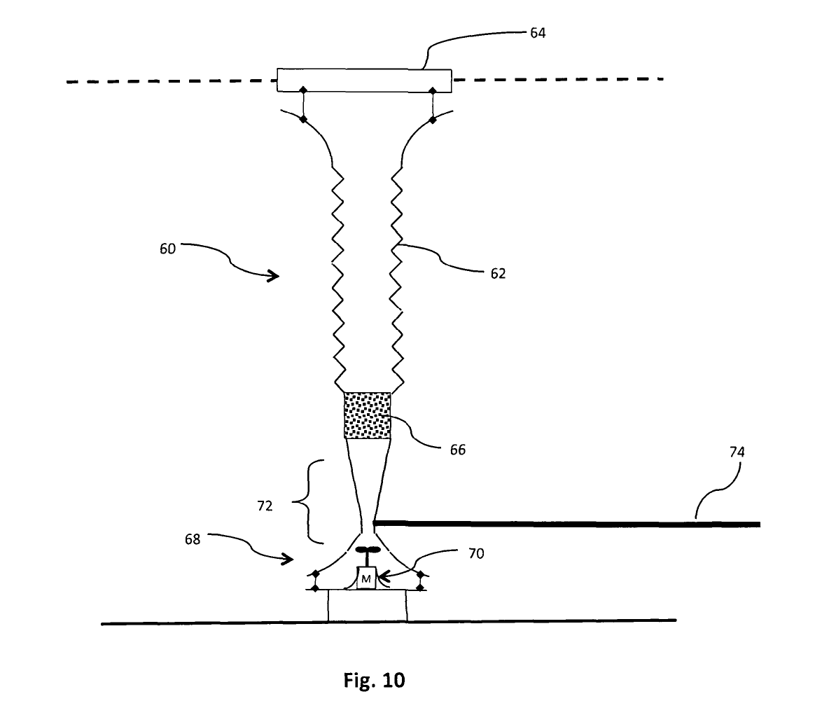

Turning to FIG. 10, there is provided a side elevational schematic view of a further embodiment of the present invention and which is particularly suited for use in small tanks or in situations where space is restricted outside the tank. The treatment apparatus 60 employs a concertina type draft tube 62 extending from a flotation member 64 to a lower region at which it is provided a packing material 66 for active treatment as required, and inlets 68 through which water is drawn into the apparatus 60, and a motor driven impellor 70 to assist in water into the apparatus 60 by the inlet 68 and directing it upwardly through the draft tube 62. This embodiment is particularly suited for use where space is limited or for other reasons it is not possible to provide a compressor to provide air to the diffuser. Rather a venturi-effect arrangement 72 comprising a venturi eductor is provided serving to draw the required gas/air via the pipeline 74 into the apparatus and so upwardly through the draft tube 62. This latter embodiment can also prove particularly efficient to operate.

Turning finally to FIGS. 11A-11G, there are provided illustrative plan views of various deployment options for different configurations of apparatus embodying the present invention. Each of views A-F relate to a rectilinear reservoir. In FIG. 11A, the apparatus represented by the dark shaded rectangle extends along a central line of the reservoir, whereas in FIG. 11B, the apparatus is provided along one side wall of the reservoir. In FIG. 11C, two draft tubes are employed along opposite side walls of the reservoir. As will be appreciated from FIG. 11D, apparatus according to the invention can be provided in each of the corners of the reservoir whereas, in FIG. 11E, a series of transversely extending draft tubes is provided along the length of the reservoir. Both of the embodiments of FIG. 11F and FIG. 11G employ draft tubes of circular section as illustrated and, in FIG. 11G. A single draft tube is provided at the centre of a circular reservoir.

As will therefore be appreciated, the present invention and, in particular, its various illustrative embodiments can advantageously be employed when liquid treatment is required and, in particular, when water treatment of some sort is required. That is, treatment solely to provide for de-stratification can readily be achieved since the distribution offered by the bellmouth and the baffles in the discharge region serves to provide for horizontal flow which significantly increases the extent of potential surface renewal and increases the oxygen transfer into the water body of the lake/reservoir. Also, with arrangements such as the present invention, the area of influence becomes far less reliance upon the potential heights of the plume, and thus the depth of the water body thereby and thereby reducing the number of devices that would otherwise be required in a shallow waters. Further, the rising plume of air/gas can now entrain water to the surface via the draft tube without having to overcome the density gradient of the Metalimnion. It has also noted above, through the use of adjustable support legs for contacting me reservoir/lake bed, the air/gas diffuser can be reliably located at a location above the sediment so as to reduce the risk of nutrients being carried to the surface region of the reservoir/lake.

From the above it will therefore be appreciated that the invention can provide for apparatus that can use air or other gas to remove volatile contaminants such as THMs from water or other liquids in storage tanks and reservoirs.

The apparatus advantageously includes an air lift pumping function to lift and circulate water from a large area, with the draft tube volume representing the gas liquid extraction contact zone.

This design can allow for the removal of contaminants from large volumes of water more cost efficiently than currently possible.

During the air/water contact, volatile contaminants will transfer from the liquid to the gas and to be removed from the water.

It should be appreciated that the invention differs from a conventional gas-liquid extraction apparatus as it is not a “once through” system, but rather represents a batch process. Also the invention sits in the liquid being treated. Once-through machines need to be very tall and are energy hungry, as they need to remove a very high fraction of contaminants in one pass. Although the invention can remove a relatively smaller fraction per pass, due to the accumulative effect of multiple passes through the reaction space it can achieve higher removal over time. Also the invention can use the extraction gas to also provide the motive force to circulate the liquid in the tank and bring in more liquid to the draft tube.

This is different to just putting a conventional air diffuser in to a tank, because of the telescopic riser pipe or draft tube and increased mixing ability. Without it, it is only possible to treat a localised area around the air plume. With the draft tube a circulation pattern is established and water is drawn in from further out and a much larger volume of water can be treated. Also the riser pipe readily allows the inclusion of media for increase contact, catalysts, etc.

It should of course be appreciated that the invention is not restricted to the details of the foregoing embodiment. For example the draft tube height is adjusted by attached floats on changing water level, or can be actuated like conventional telescopic bellmouth. It can of course be a circular cylinder, rectangular or any other cross section.

The elements thereof can be fitting, or with gaps/induction orifices to “induce” more flow in to the riser pipe at various depths and increase water movement in the water volume. It could further include baffles to direct flow, prevent eddies and energy losses etc. Might include baffles to vortex water in a manner similar to rifling in gun barrel, or could be of a concertina form instead of telescopic arrangement.

If provided, the bellmouth can serve to discharge water with lower energy loss. It could include fins/baffles to direct flow and prevent eddies and energy losses.

The floatation members can be arranged to keep the bellmouth at fixed position relative to the water level. However, they could be replaced by an actuator to lower and raise the bellmouth.

The packing material can be fluidised, packed and/or structured and either simply for surface contact or catalytic or even active, e.g. activated carbon, manganese removal catalyst, ion exchange resin etc.

Also, flow measuring functionality can be included, particularly in the region of the exit of the arrangement such that, for example, sensors offering at least one of flow measurement, water characteristic and water quality measurements, can be provided in the water path within the arrangement.

As further features of the present invention, electromagnetic radiation such as UV light and/or a magnetic field and/or ultrasound, can be applied to the fluid passing through the apparatus as required so as to further improve the fluid quality.

1. A liquid treatment apparatus arranged for submersion in the said liquid and comprising a draft tube arrangement extending from an upper region of the apparatus to a lower region thereof, floatation means provided at the upper region, gas introduction means located at the lower region and arranged for the introduction of gas into the draft tube arrangement to create a lift for liquid there-through and for the said treatment thereof.

2. Apparatus as claimed in claim 1, wherein the draft tube has a collapsible configuration so that the longitudinal dimension of the draft tube can vary responsive to the change in depth of liquid in which the apparatus is submerged.

3. Apparatus as claimed in claim 1, wherein at least the lower region of the draft tube is arranged to be provided with support members extending therefrom for engagement with the lower surface of the formation within which the liquid is stored.

4. Apparatus as claimed in claim 3, wherein the support members comprise means for anchorage of the draft tube to the said lower surface.

5. Apparatus as claimed in claim 4, wherein the support members comprise a plurality of leg members extending from a lower region of the draft tube.

6. Apparatus as claimed in claim 3, wherein the said support members are adjustable to vary the position of the apparatus.

7. Apparatus as claimed in claim 1 and including packing means provided within at least a portion of the draft tube.

8. Apparatus as claimed in claim 7, wherein the packing means is arranged to support growth of biological fixed film for removing organic contaminants from the water.

9. Apparatus as claimed in claim 1, wherein an active medium is provided within the draft tube.

10. Apparatus as claimed in claim 1 wherein a catalytic medium is provided within the draft tube.

11. Apparatus as claimed in claim 1 wherein apertures are provided at selected regions through the wall of the draft tube so as to allow for the additional introduction of liquid thereto and as a result of the said air lift.

12. Apparatus as claimed in claim 1 and including an impeller arrangement provided in relation to the draft tube and for assisting with movement of liquid through the draft tube.

13. Apparatus as claimed in claim 12, wherein the impeller arrangement is provided so as to urge liquid downwardly through the draft tube and in the direction opposite to that of the gas rising therethrough from the gas introduction means.

14. Apparatus according to claim 1 and including means for introducing electromagnetic radiation, and/or electromagnetic radiation in the presence of a catalyst, and/or a magnetic field, and/or ultrasound, and/or electrochemical treatment to the liquid.

15. Apparatus according to claim 1 and arranged for water treatment such as de-stratification and/or contaminant extraction.

16. Apparatus according to claim 1, wherein the gas introduction means comprises a compressor arrangement.

17. Apparatus according to claim 1, wherein the gas introduction means comprises a venturi effect arrangement.

18. Apparatus as claimed in claim 1, wherein collapsible inlet and/or outlet diffuser arrangements are provided.

19. Apparatus as claimed in claim 1, and including at least one of a flow-measurement sensor, water-characteristic sensor and water-quality sensor within a flow path.

20. A method of contaminant-extraction from liquid and including the step of drawing the liquid through a draft tube submersed within the said liquid by means of an air lift arrangement whereby the introduction of the gas so as to provide for the air lift also provides for the said contaminant extraction.

21. A method as claimed in claim 20 and including varying the longitudinal dimension of the draft tube responsive to a change in depth of liquid in which the apparatus is submerged.

22. A method as claimed in claim 20, and including drawing the liquid over an active medium provided within the draft tube for assisting with the contaminant-extraction.

23. A method as claimed in claim 20, and including drawing the liquid over a catalytic medium provided within the draft tube.

24. A method as claimed in claim 20, and providing for water treatment such as de-stratification and/or contaminant extraction.

25. A method as claimed in claim 20 and including the step of directing electromagnetic radiation, and/or electromagnetic radiation in the presence of a catalyst, and/or a magnetic field, and/or electrochemical treatment, and/or ultrasound towards the liquid.

26. A method as claimed in claim 20 and urging the liquid in a direction within the draft tube in a direction opposite to that of the air lift.

27. A method as claimed in claim 20 and including the step of adjusting volumetric flow and/or velocity of the water.

28. A method as claimed in claim 27, wherein the adjusting step includes at least one of varying the dimension and/or configuration of an outlet weir and/or varying the speed of the impeller, and/or bearing the blade number/configuration of the impeller.

29-30. (canceled)
